(19) United States
(12) Patent Application Publication
(10) Pub. No.: US 2003/0055886 A1
(43) Pub. Date: Mar. 20, 2003

(54) Method for producing complex image

(76) Inventor: Tobias Huettner, Gaeufelden (DE)

Correspondence Address: QUARLES & BRADY LLP, 411 E. WISCONSIN AVENUE, SUITE 2040, MILWAUKEE, WI, 53202-4497, US

(21) Appl. No.: 10/201,579

(22) Filed: Jul. 22, 2002

(30) Foreign Application Priority Data
Jul. 23, 2001 (DE) 10136988.3

(51) Int. Cl. G06F 15/16

(52) U.S. Cl. 709/203

(57) ABSTRACT

According to the method of the invention complex images are displayed on the display unit of a work station, for which purpose the latter is connected to at least one server. The work station produces values of parameters influencing the image data to be displayed. The values of the parameters are transmitted to the at least one server. On the basis of the values of the parameters the at least one server determines the image data to be displayed. The determined image data are then transmitted back to the work station. At the work station is then produced an image corresponding to the image data and is displayed on the display unit.

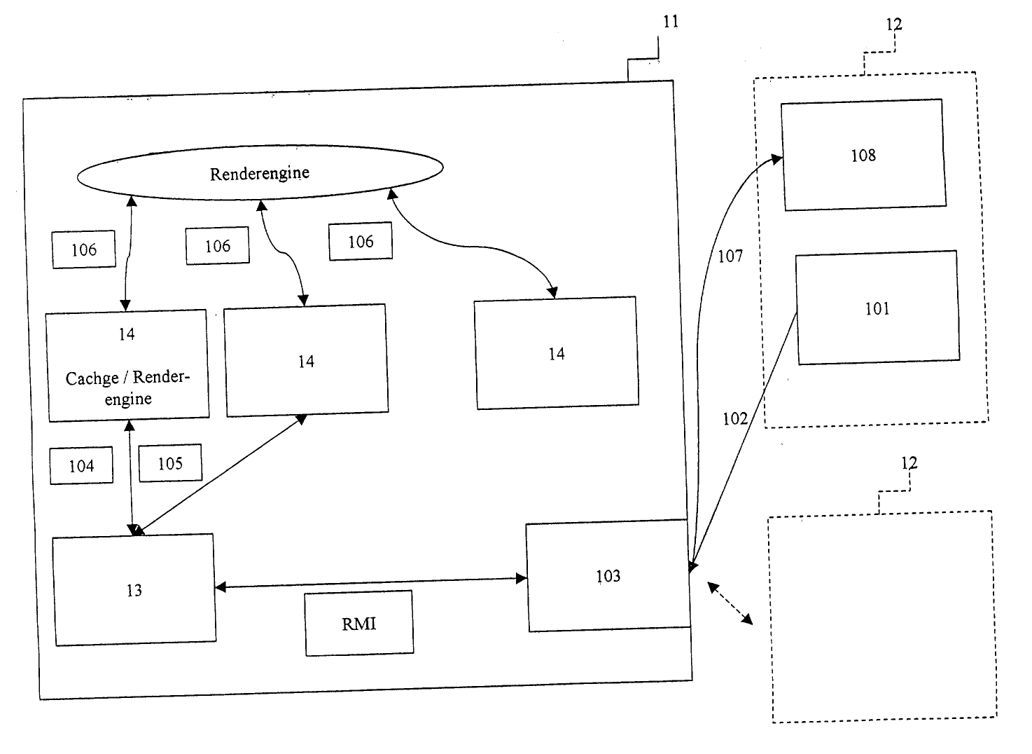

The present invention relates to a method for producing complex images on a work station with a display unit for displaying the image, the work station being connected to at least one server.

If complex images or graphics are to be displayed on computers, the production thereof involves a very considerable computing expenditure and effort. Thus, conventionally on operating position equipment the computers are equipped with graphic display adaptors, which produce in “real time” the images or the control signals for the same. The control signals are conventionally applied to the work station display unit, which then generates a corresponding image. The computing capacity of conventional graphic display adaptors is not sufficient if complex image structures are to be displayed. This is particularly the case when the images to be displayed are three-dimensional structures, where from the predetermined structures it is initially determined what is visible and then how the visible is displayed. This more particularly applies if the image has a very large area and is displayed with a high resolution and when the display of the two-dimensional projection of the image or a section thereof requires considerable search effort and expenditure.

Such complex image structures are normally processed on servers in parts specifically programmed for this purpose. For displaying such complex structures the data sets from which the image is calculated are present in a predetermined structure. The image is then determined, namely rendered in accordance with a specific method. Rendering is a method in which initially it is established how the projection of the three-dimensional structure appears on the two-dimensional image plane by determination on the basis of parameters from a grid diagram of the object to be displayed. Determination then takes place with respect to each area present which is bounded by the grid lines of the so-called texture, i.e. the data with which said area is to be filled. With a very high resolution the texture, in the manner stored in the data with respect to the grid structure, contains information, e.g. regarding the colour of the area. From the data existing with a very high resolution, during rendering for the display of the field filled with said texture on the display unit, the colour values of the image points contained in this field are determined as a function of the resolution of the display unit and the area.

Such rendering methods are conventionally used if very large and complex image structures, e.g. three-dimensional models of real topographies, such as can be used particularly in environmental and other maps, are required. During image processing the problem arises that the data sets to be processed are extensive.

Therefore such images can only be determined on large computers specializing in such functions. This problem becomes worse if the displayed image is to be determined with short image generation times coming as close as possible to real time.

Thus, the problem of the invention is to provide a method with which such complex images can be displayed on work stations not specialized with respect to image processing. The method according to the invention is also particularly intended to make it possible to display such complex images on a plurality of work stations not specialized for image calculation with their display units and whilst maintaining short response times.

The problems of the invention are solved by a method according to the independent claim.

According to the method of the invention the complex images are displayed on the display unit of a work station and for this purpose the latter is connected to at least one server. In the work station are produced values of parameters influencing the image data to be displayed. The values of the parameters are transmitted to the at least one server. On the basis of the values of the parameters the image data to be displayed are determined by the at least one server and are then transmitted back to the work station. In the work station is then produced an image corresponding to the image data and is displayed on the display unit thereof.

The work stations are usually conventional work stations, such as are of a conventional nature in PC's. Servers are generally powerful computers or computer systems, which are suitable for processing requests from their connected clients or work stations.

The connection between the work stations or clients and the servers can take place by means of a network, particularly the Internet. The network structure can be any other network through a local or supralocal network, so-called LAN's or WAN's. In special cases a client and a server can run as a process on a common computer.

Each work station can contain a graphic unit, particularly a graphic display adaptor, which, on the basis of the image data supplied thereto and which can be filed in a working memory or a separate memory for this purpose, produces the control signals for the display unit consequently leads to the generation of the image on the display unit.

According to a further development of the invention the values of the parameters are produced by means of an object, particularly an applet, which is embedded in the image displayed by the display unit.

The applet is in particular a short program segment embedded in the image to be displayed and which produces the values of the parameters as a result of modifications performable by the work station user to the image displayed by the display unit. This can e.g.. take place in that for at least part of the parameters on the screen graphic simulation takes place of in each case one sliding control or some other control element. The modification to the sliding control position takes place on the screen through the user. The applet then calculates and outputs a value of the quantity associated with the sliding control position.

The parameters in particular determine an observer position with respect to the object to be displayed. The parameters preferably include at least one of the quantities viewing point (position and range), viewing direction and/or inclination angle of the viewing direction with respect to the horizontal of the object.

According to a further development of the invention the image data are determined by rendering in the at least one server.

According to a further development of the invention the at least one server has at least two working units. Each of these working units is suitable for generating or determining image data and the construction is particularly such that a processor, which can be specially designed for this purpose, is provided for image data calculation. A temporary or buffer memory, a so-called cache memory, is available to each of these processors. The temporary memory can be located both on the processor and in the environment of the latter, e.g. on a common circuit board. According to the further development of the invention a portal is provided on the side of the at least one server. The portal can be constructed as a logic unit within the at least one server. The portal is responsible for the distribution of the parameters entering the server for image data determination at one of the working units. The function of the portal also includes the association of parameters with the work station for transmitting back the image data determined to the particular work station from which the parameters were transmitted to the server.

The working units can fall back on a common library of calculating routines, particularly rendering routines, for image data determination. They in particular use a common data set in which is filed more particularly the three-dimensional original or master of the image to be displayed. This master in particular comprises all the data necessary in order to observe the object under all viewing angles and directions. it has a very high resolution.

In order to reduce the response time of the at least one server, particularly when there are numerous work stations, and in order to avoid unnecessary calculating work in the vicinity of the server and therefore unnecessary occupancy of the working units of the at least one server, it is possible to check whether in a temporary memory at the given time image data are stored which, at the most, only differ insignificantly from the image data to be generated on the basis of the present values of the parameters. This check can e.g. take place in the portal. Thus, it is checked whether at present a temporary memory contains in filed form data of an image determined on the basis of the values of parameters, which were transmitted at an earlier time to the at least one server and which essentially correspond to the current transmitted parameter values. Apart from the given temporary memory of the working units it is possible for this purpose to provide a separate memory in the vicinity of the at least one server, in which the image data are stored which are associated with specific values of the parameters. The specific parameter values can e.g. include a number of the last preceding transmissions of the values of parameters or also the image data of particularly frequently occurring values of the parameters. Determination e.g. then takes place in the server portal as to whether in the vicinity of the server are stored image data which at the most differ only insignificantly from the image data to be generated on the basis of the present values of the parameters.

For this purpose a metric can be provided, which determines a measure for the divergence of the image on the basis of the transmitted values of the parameters for the image to be displayed and image data stored on the basis of the parameter values. Whilst using an error barrier, from the measure of the divergence it is possible to determine whether there is a significant difference between the transmitted values of the parameters and the values of the parameters of a stored image data set. The error barrier is determined as a function of the resolution of the display unit of the work station, which has transmitted the parameters for the image produced. It is possible to determine as a function of the image resolution whether an image to be displayed for different parameters would in fact have diverging image data. A divergence leading to no visible difference between the image data can be looked upon as insignificant. Using the metric together with the error barrier, the portal can clearly differentiate on the basis of the values of the parameters of the image data to be compared whether the two different image data sets do or do not differ significantly from one another.

These and further features of the invention can be gathered from the claims, description and drawings and the individual features, both singly and in the form of subcombinations, can be implemented in an embodiment of the invention and in other fields and can represent advantageous, independently protectable constructions for which protection is claimed here.

The invention is described in greater detail hereinafter relative to the single drawing of an embodiment, which shows the sequence of the method of the invention in block diagram form. The connection between the work station and the at least one server takes place by means of the Internet, i.e. a data net working with the so-called TCP/IP protocol.

According to a first method step 101, a set of values of parameters is produced on the work station. For this purpose is more particularly used an embedded object, e.g. an applet. The embedded object could be a HTML input primitive or a Java script.

According to step 102, following the production of the values of the parameters by the work station 12, a request is sent to the at least one server 11, which includes the values of the parameters. This makes use of the interconnection of the computers. The network protocol in particular functions according to the TCP/IP protocol. The request is in particular a http request.

Reception takes place on the server side of the parameter values according to step 103. By means of a servlet or e.g. a JSP page (Java Server Page), the parameter values of the request are received. A portal 13 is polled, e.g. by means of a RMI (Remote Method Invocation). The portal 13 is the unit controlling the determination of image data. The portal 13 is used for coordinating individual working units 14, which are available as processes on different processors for image data determination. Before a working unit 14 receives the instruction from portal 13 to determine the image data in connection with the transmitted values of the parameters, a check is made as to whether in a temporary memory or in an image memory have already been filed corresponding image data with respect to some other, similar set of parameters and which can therefore be polled and transmitted back by direct memory access. For this purpose use is made of a metric, which serves to find whether an image or its image data only insignificantly differ from an already stored image.

Such a metric in particular includes the parameters of the current image data, the parameters of the already generated images, as well as an error barrier. A set of parameter values, i.e. the complete group of parameters, can in particular include at least one of the following quantities: viewing point, viewing direction and inclination angle to the horizontal. Essentially the values of the parameters determine the observer position with respect to the object to be displayed on the image. A parameter value can also include the resolution of the display unit of the work station. Hereinafter the parameters of the viewing point are designated with the indices x, y and z and the parameters of the viewing direction and inclination angle with the indices a and b.

A simple metric for this determination is e.g. provided by the function

$$\begin{matrix}f ( ex , ey , ez , ea , eb ) = int ( ex / tx ) - bx + \\ int ( ey / ty ) - by + \\ int ( ez / tz ) - bz + \\ int ( ea / ta ) - ba + \\ int ( eb / tb ) - bb\end{matrix}$$

in which tx, ty, tz, ta and tb are divider constants, bx, by, bz, ba and bb the parameter values of the already stored images or their image data and ex, ey, ez, ea and eb are the parameters of the current observer position. From a viewing point (x, y, z) with viewing direction (a, b) a corresponding parameter value p is obtained with the index x via the relation px=int (x/tx), where the function int can correspond to the function used in the programming language C. The values of the parameters py, pz, pa and pb are calculated in the same way. A check is then made to establish whether the function value of the metric f(ex, ey, ez, ea, eb) for the current image with the parameter values ex, ey, ez, ea and eb is smaller than an error barrier epsilon. In this case use is made of the image or its image data with the parameters bx, by, bz, ba and bb from the temporary memory. Otherwise the image must be redetermined by rendering.

The result of the determinations based on the metric is a binary yes/no answer to the question as to whether images already filed in the memory can or cannot be used. If an already filed image can be used, the portal 13 transmits back to the work station 12 the corresponding Image data set.

In the case where the binary answer is no and therefore a new image must be calculated or rendered, according to step 104 the portal produces via RMI an access to one of the working units 14, where the image data of the new image are determined. For this purpose and according to step 106 e.g. by means of JNI (Java Native Interface) it is possible to use the joint filed image data of the master, whose projection on the image plane is determined and calculated as image data of the image to be generated. in this way it is also possible for the working units 14 to access centrally filed and performed rendering routines, e.g. programmed in C++, a so-called fly-away system. The fly-away system determines the image data of the image to be generated as soon as the corresponding working unit in accordance with step 106 has transmitted the request and the necessary data. The fly-away system transmits the image data generated back to the working unit 14. According to 105 the image data are then transmitted back to the portal 13, which forwards the same to the web server, e.g. via RMI. The web server transmits the image data, e.g. as HTML frame or JSP page (Java Script Page) in step 107 to the work station 12 from which the request emanated. According to step the display unit in the work station is controlled on the basis of the image data received in such a way that it displays the corresponding image.

1. Method for producing a complex image on a work station (12) with a display unit for displaying the image, the work station (12) being connected to at least one server (11), with the following steps:
values of parameters are produced in the work station (12) which influence the image data to be displayed,
the values of the parameters are transmitted to the at least one server (11),
on the basis of the values of the parameters the image data to be displayed are determined by the at least one server (11),
the image data are transmitted back to the work station (12) and an image corresponding to the image data is produced by the work station (12) and displayed on its display unit.

2. Method according to claim 1, characterized in that the values of the parameters are determined by means of an object, particularly an applet, which is embedded in the image to be displayed by the display unit.

3. Method according to claim 1 or 2, characterized in that the parameters determine an observer position with respect to an object to be displayed.

4. Method according to one of the preceding claims, characterized in that the parameters include at least one of the quantities: viewing point, viewing direction and inclination angle to the horizontal.

5. Method according to one of the preceding claims, characterized in that the image data are determined in the at least one server by rendering.

6. Method according to one of the preceding claims, characterized in that the at least one server has at least two working units (14), each of said working units (14) being suitable for generating image data and by means of a server-side portal (13) the parameters for image data determination are distributed to one of the working units (14).

7. Method according to claim 6, characterized in that the working units (14) use a common library of calculating routines, particularly rendering routines, for determining the image data.

8. Method according to one of the preceding claims, characterized in that a check is made by means of a metric as to whether a temporary memory, particularly an image data memory associated with a working unit, is storing image data which only differ insignificantly from the image data to be determined on the basis of the present values of the parameters and if the image data only differ insignificantly the corresponding, stored image data can be transmitted back to the work station.

9. Method according to claim 8, characterized in that by means of the metric only an insignificant difference is detected if the divergence between the values of the parameters of the image to be displayed and the values of the parameters of the stored image is below an error barrier.

10. Method according to claim 9, characterized in that the error barrier is determined as a function of the resolution of the display unit of the work station, which has transmitted the parameters for the image to be generated.
